(19) United States
(12) Patent Application Publication
(10) Pub. No.: US 2013/0173412 A1
(43) Pub. Date: Jul. 4, 2013

(54) Method And System For Controlling Freight Bidding

(71) Applicants: John Motley, Rumson, NJ (US); Eric Barnes, Forked River, NJ (US); Louis Masters, Monroe, NJ (US); Logan Schobel, Waretown, NJ (US); Michael Martinock, Eatontown, NJ (US)

(72) Inventors: John Motley, Rumson, NJ (US); Eric Barnes, Forked River, NJ (US); Louis Masters, Monroe, NJ (US); Logan Schobel, Waretown, NJ (US); Michael Martinock, Eatontown, NJ (US)

(73) Assignee: Log-Net, Inc., Red Bank, NJ (US)

(21) Appl. No.: 13/341,163

(22) Filed: Dec. 30, 2011

(51) Int. Cl. G06Q 30/00

(52) U.S. Cl. 705/26.4

(57) ABSTRACT

A system and method for bidding freight transportation is disclosed. The system and method includes means for comparing bids and determining differences in the bids from different carriers based on a number of different input parameters. The system and method also includes means for comparing bids to a historical baseline and as the bidding process goes through an iterative process.

### BACKGROUND

Controlling the cost and efficiency of freight transportation is important to many companies, particularly those with high transportation costs. To these companies, freight bidding is an important process. It can also be a disruptive process because it is a difficult process.

When processing freight bids, it is usually important to understand freight charges up front. Considering the use of new freight transporters can help increase the competitiveness of bids and to save money. However, there are many problems with the freight bidding process that makes it difficult to implement.

For example, all of the information needed to correctly analyze bids is often difficult to put together. In some cases, this is because all of the information is not available. In other cases, the difficulty lies in the complexity of the data and the lack of tools to process the data and transform the data so that it can be analyzed in a meaningful manner.

The freight bidding process is also problematic because of the large number of options available. This makes it difficult to compare bids.

Improved freight bidding tools, systems and methods are needed to allow companies to reduce their transportation costs and to allow companies to improve the efficiencies in their freight transport.

### SUMMARY

The present invention provides systems and methods to allow comparative bidding and bidding analysis for freight delivery to be performed. A system and method for analyzing the data provided during the request for quotation process associated with the transportation of products around the world. Carriers participating in a request for quotation will provide their freight and accessorial charges for the transportation of a product from an origin to a destination. In addition to the origin and destination, the carrier will be able to enter a variety of other attributes that may influence a charge, including but not limited to, discharge port, load port, container type/size/height, and service level. These charges will be loaded into the system by the carrier using a computer interface. Once the charges have been loaded, a computer interface can be used to aggregate the data based on key attributes. Any of the attributes pertaining to a charge that were entered by the carrier can be selected as a key attribute. Each set of key attributes used to create a unique presentation of the data can be stored as a view to be reused during different stages of data analysis. The collection of these views will simplify the process of comparing data between carriers on the attributes of concern. These views will also assist in spotting changes between the rounds of a request for quotation by allowing side by side comparison of the data that was provided by a carrier during one round with the data that the same carrier provided in a subsequent round.

In accordance with an aspect of the present invention a method of providing a freight bid to a party over a network is provided. The method includes the step of a processor receiving a completed bid request form from the party over the network, the completed bidding interface specifying a lane, one or more carriers and a plurality of parameters to specify a bid. Then the processor accesses a database of historical bidding information using the lane and at least one of the plurality of parameters to determine a preliminary baseline of information related to the bid and then transmits a bid form to the one or more carriers over the network, the bid form including the lane and the plurality of parameters to be completed. Then the processor receives a completed bid form from the one or more carriers over the network, the completed bid form specifying the lane and information relating to the plurality of parameters. The processor then accesses the database using the lane and the set of information related to the plurality of parameters to determine a second baseline related to the bid. The processor then transmits a bid comparison form to the party over the network, the bid comparison form including the preliminary baseline next to the second baseline.

The processor also can calculate one or more differences between the second baseline and the preliminary baseline and show the difference on the bid comparison form sent to the party.

The processor can also, in a first step, transmit an uncompleted bid request form over the network to the party, the uncompleted bid form including entry fields for the party to specify the lane and the plurality of parameters related to the bid.

In accordance with an aspect of the present invention, the completed bidding interface specifies the bidder, and the processor uses the bidder to access the database to determine the preliminary baseline, and the processor uses the bidder to access the database to determine the second baseline.

The plurality of parameters can be selected from the group consisting of ORIGIN REGION, ORIGIN CITY, ORIGIN CITY NAME, ORIGIN SITE, ORIGIN FACILITY, ORIGIN FACILITY TYPE, ORIGIN COUNTRY, DESTINATION REGION, DESTINATION CITY, DESTINATION CITY NAME, DESTINATION SITE, DESTINATION FACILITY, DESTINATION FACILITY TYPE, DESTINATION COUNTRY, LOAD PORT, DISCHARGE PORT, TYPE OF CONTAINER, SIZE OF CONTAINER, HEIGHT OF CONTAINER, COMMODITY CODE, SERVICE LEVEL, RATES, ORIG DATE, DEST DATE, EFFECTIVE DATE, EXPIRATION DATE, and combinations thereof.

The present invention also contemplates a system to perform the steps described herein. The system includes a server that communicates with a network, such as the Internet. The server communicates with a party desiring to receive freight bids and with a plurality of carriers. The server includes a memory to store data and a set of operating instructions and a processor in communication with the memory, the processor operable in accordance with the set of operating instructions to perform steps described herein

### DESCRIPTION OF THE DRAWINGS

FIG. 1 illustrates a system in accordance with an aspect of the present invention.

FIG. 2 illustrates a processor system used in accordance with various aspects of the present invention.

FIGS. 3 and 4 illustrate steps performed in accordance with an aspect of the present invention.

FIGS. 5 to 13 illustrate various interfaces used in accordance with various aspects of the present invention.

FIGS. 14 and 15 illustrate a process to drill down into rates in accordance with an aspect of the present invention.

### DESCRIPTION

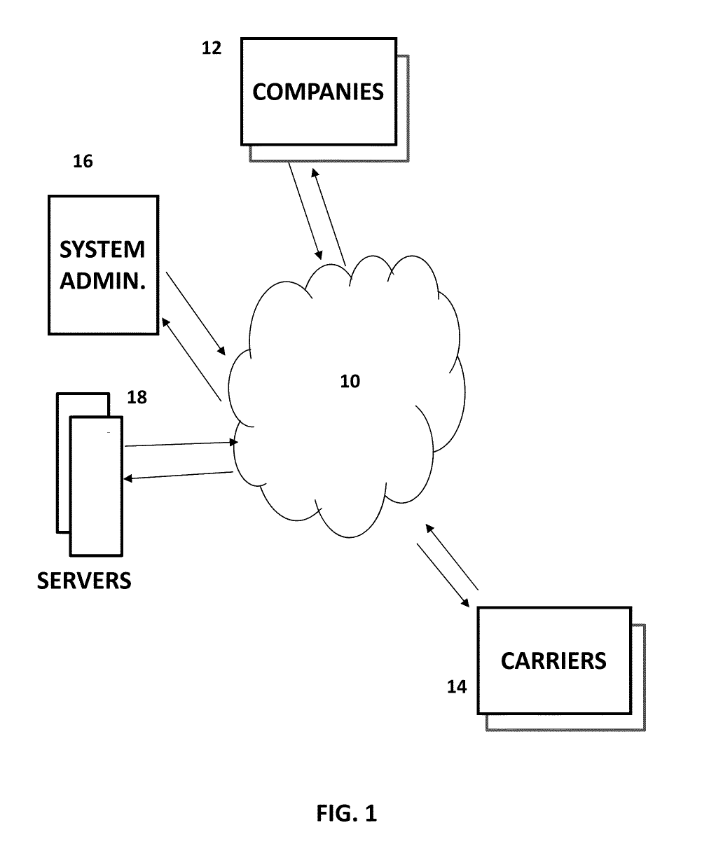

FIG. 1 illustrates a system in accordance with an aspect of the present invention. In accordance with an aspect of the present invention, various entities communicate over a network 10, which is preferably but not necessarily the Internet. The entities communicating via the Internet include a plurality of entities needing freight transportation 12, a plurality of carriers 14 and a system administrator 16. The system administrator 16 may utilize servers at its network location to implement the steps of the present invention. Alternatively, servers 18 located elsewhere on the network 10 can also be used by the system administrator 16 to implement one or more of the steps of the present invention. In accordance with an aspect of the present invention, these entities communicate to provide new and improved freight bidding and services.

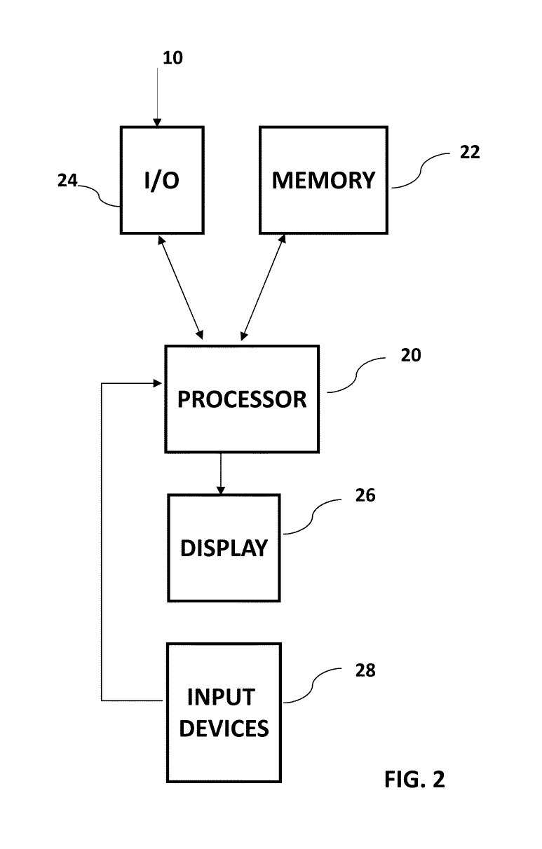

Each of the entities, including the entities needing freight transportation 12, the carriers 14 and the system administrator 16 has a computing system, including a processor, at its location. FIG. 2 illustrates a typical processor system used in accordance with various aspects of the present invention. It includes a processor 20, a memory for processor instructions and data storage 22, an input/output source 24, a display 26, and input devices 28.

The processor 20 operates in accordance with the instructions in the memory 22. The memory 22 is therefore programmed to include an instruction set to perform the steps described herein for each entity 12, 14 and 16. The processor 20 receives data from the input/output source 24 which is connected to the Internet 10. The processor 20 can store data, as needed in the memory 22.

A user can interface with the system of FIG. 2 through the display 26 and the input devices 28. The system of FIG. 2 can be a standard personal computer, laptop, a special design computer, a workstation, or the like. The processor 20 is used by each entity 12, 14 and 16 to process the data in accordance with the steps described herein.

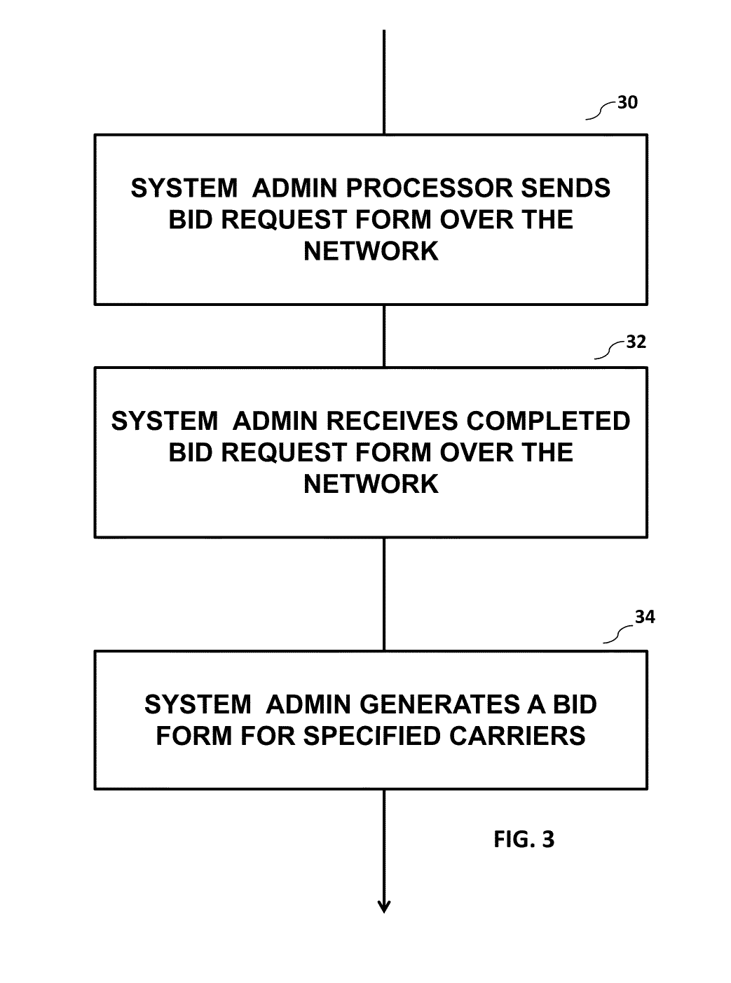

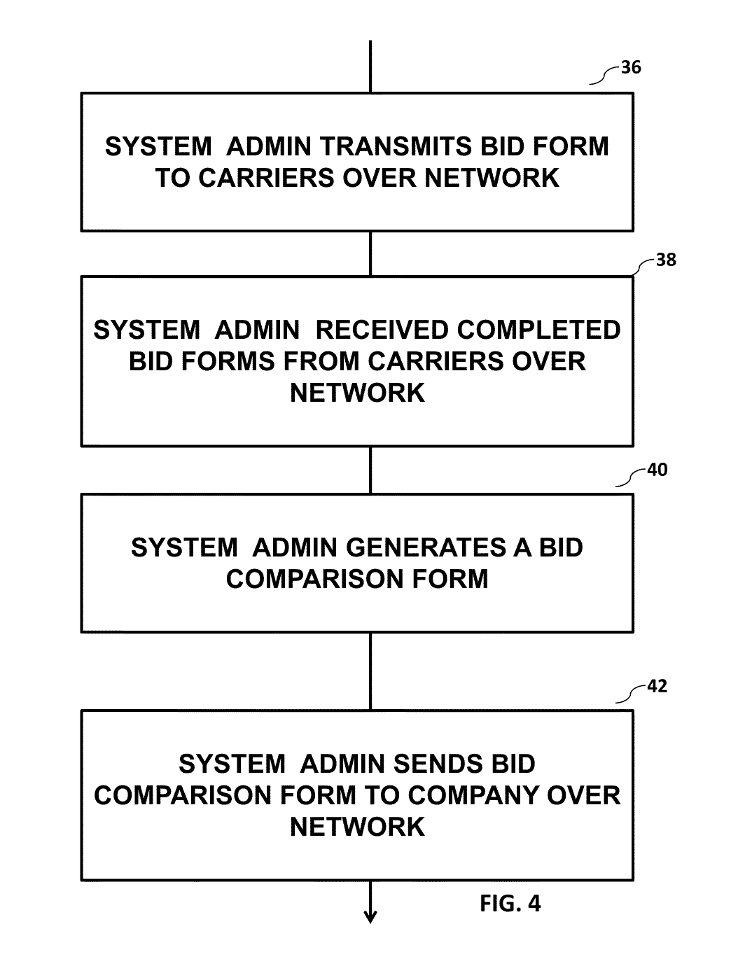

FIGS. 3 and 4 illustrate steps performed in accordance with an aspect of the present invention. In step 30, the system administrator 14 sends an uncompleted bid request form over the network to a company 12. This step can be accomplished in any number of ways. The company 12 can send a bid request over the Internet 10 to the system administrator 16, who can then send a bid request for to the company 12 to complete. The bid request form includes a “lane.” The lane specifies the starting point and the end point of the freight to be transported. The bid request form also includes an area where certain bidders can be identified.

The use of the word “send” is meant to cover any way of transmitting information to the company 12 or to any other party mentioned herein. Thus, the company 12 can log into the system administrator 16 to gain access to the information, and the information is then “sent” to the company 12. Alternatively, the company 12 can receive the information after it is sent by the system administrator 14 in any fashion. This definition of send and sent applies throughout this specification.

The bid request form can also include related information to be completed by the company 12: The following parameters are a non-exclusive list of the parameters that can be included on the bid request form:

ORIGIN REGION—typically North America or Asia, but can be other regions.

ORIGIN CITY—typically represented by a code (e.g., HKG for Hong Kong, LAX for Los Angeles)

ORIGIN CITY NAME—full name of origin city.

ORIGIN SITE—carrier specific location within city.

ORIGIN FACILITY—carrier facility at a specific site.

ORIGIN FACILITY TYPE—Type of facility (Warehouse, Container Yard, . . . ).

ORIGIN COUNTRY—country.

DESTINATION REGION—North America, Asia.

DESTINATION CITY—code (HKG, LAX).

DESTINATION CITY NAME—full city name (Hong Kong).

DESTINATION SITE—carrier specific location within city.

DESTINATION FACILITY—carrier facility at a specific site.

DESTINATION FACILITY TYPE—Type of facility (Warehouse, Container Yard, . . . ).

DESTINATION COUNTRY—country.

LOAD PORT—Port where the containers are loaded onto a vessel.

DISCHARGE PORT—Port where the containers are removed from a vessel.

TYPE—Type of container (Dry, Refridgerated, . . . ).

SIZE—Length of the container.

HEIGHT—Height of the container.

COMMODITY CODE—Code used to represent the specific commodity.

SERVICE LEVEL—Method of transportation (IPI, RIPI, MLB, AW, . . . ).

RATE—rates to be charged by carrier.

ORIG DATE—Date container will be at the origin.

DEST DATE—Date container will be at the destination.

EFFECTIVE DATE—Effective date for the rate offered by the carrier.

EXPIRATION DATE—Expiration date of the rate offered by the carrier.

The company 12 completes the form to specify the lane being bid, which carriers the company 12 is interested in having offer bids and the parameters that each carrier should include in their bid.

Additionally, the process contemplates the company 12 being able to specify which of the parameters should be included in the bidding process. This can be performed by providing a checklist of parameters which are checked if they are to be included. The checklist can be provided to the company 12 by the system administrator 16 via the Internet 10 upon request by the company.

Alternatively, a program can be downloaded once by the company 12 from the system administrator 16 over the Internet 10 to allow the company to complete a bid request form and then used as needed by the company 12.

The company 12 can complete the information on the form and send it to the system administrator 16. All of these steps are performed by the processor 20 at the respective entities. Alternatively, the bidding form can be stored in memory at the company's 12 computer systems, completed there and sent to the system administrator.

Multiple companies 12 can interface with the system administrator 14 over the network 10 in this manner.

In step 32, the system administrator's 16 computing system receives the completed bid request form from a company 12 over the Internet 10. The processor 20 at the system administrator 16 causes the information in the bid request form to be stored in its associated memory, preferably in a database in association with the company's 10 identity and with a bid request number.

After receiving the completed bid request form from the company 12 and saving the specified lane and the bidding parameters to be used, in step 34 the processor 20 at the system administrator 16 causes a bid form to be created. In accordance with an aspect of the present invention, a bid form is created for each carrier 14 specified in the bid request form that the system administrator 14 receives from the company 12. The bid form also preferably includes a list of all of the parameters that the company 12 would like a carrier 14 to specify in their bid, as well as a space for that information to be completed.

In step 36, the system administrator 16 transmits the bid form to one or more of the carriers 14 specified in the bid request form. Each of the carriers 14, after receiving the bid form, complete the bid form with the parameters that have been previously specified by the company 12 requesting the bid. The carriers 14 transmit the completed bid form back to the system administrator 16.

In step 38, the system administrator 16 receives a completed bid form from each of the carriers 14 over the Internet 10 or other network. The completed bid form includes the specified lane, the carrier 14 completing the form and the specified parameters completed by the carrier 14. Thus, the system administrator 16 may receive multiple completed bid forms, one from a plurality of different carriers 14, that relate to a lane and a company 12. After receiving each completed bid form, the processor 20 at the system administrator 16 causes the information in the completed bid form to be stored in the memory at the system administrator 16.

In step 38, the processor creates a bid comparison form based on the information a carrier 14 has entered on the bid form and based on historical data relating to bids. The historical data is related to the parameters specified in the original bid request form. The historical data can be stored at the memory of the system administrator 16.

The processor at the system administrator 16 can also create a bid comparison form that includes information from a plurality of carriers 14. The plurality of carriers 14 can be the carriers 14 originally specified by the company 12 in the bid request form.

The processor can also calculate differences between the current bid and historical bids. These differences can be displayed by the processor 20 on the bid comparison form.

In step 40, the processor at the system administrator 16 sends the bid comparison form to the company 12 over the network 10.

These steps can be performed by a plurality of companies 12. Thus, the system administrator 16 is providing freight bidding services to a plurality of companies 12 over the Internet 10.

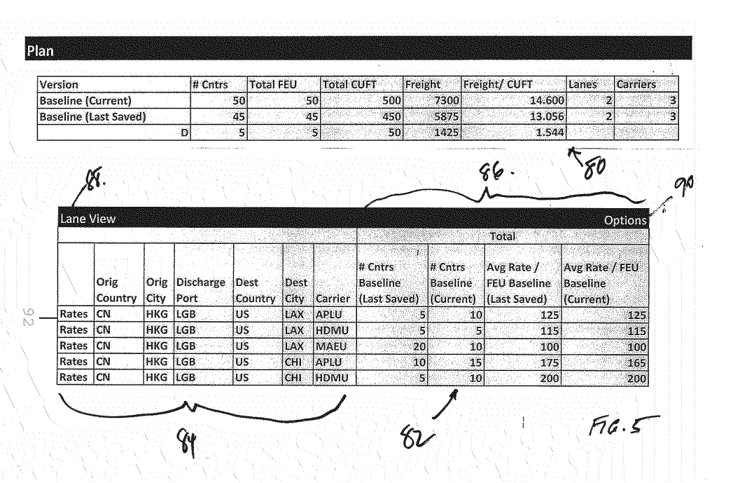

FIG. 5 illustrates an exemplary bid comparison form. At the top of the form is a comparison section 80. The comparison section 80 includes a current baseline (top line) and a last saved baseline (second line). These two lines can be a summary of the first bid by a carrier compared to historical information from the carrier. The historical information is determined by the processor 20 at the system administrator 14 for the carrier making the bid based on previous transportation historical rates and the other information indicated.

The processor 20 at the system administrator 14 can also calculate a difference between the current baseline and the last saved baseline. The processor 20 at the system administrator 14 causes those differences to be displayed on the bid comparison form of FIG. 5.

Also, the bid comparison form of FIG. 5 can illustrate a summary of each bid received by each carrier. Thus, a line for each carrier can be displayed in the bid comparison form section 80. A line of historical bid information can also be displayed. The historical bid information can be an average of the information. The historical bid information can also be the lowest value of a selected parameter.

The bid process described above in FIGS. 1 to 4 can be iterative. Thus, the company 12 can issue requests to one or more carriers 16 to modify their bids as they relate to any of the previously indicated parameters. When a carrier 16 completes a bid form with the new information, the carrier 16 sends the new bid form to the system administrator 14 over the network 10. The system administrator 14 stores the new bid form and the new information in its memory. The processor 20 at the system administrator 14 determines a new bid comparison form and stores that form as well. The new bid comparison form sets forth the current baseline, based on the new bid information, and the previous baseline, based on the last bid information just prior to the current baseline.

The bid comparison form can also include a view of the current bid in a bid view section 82. The bid view section has two sections 84 and 86. The first section 84 shows the input parameters that are used to generate the view. The second section 86 shows the values that result from the input parameters. Thus, a processor 20 at the system administrator 14 receives the input parameters and accesses a database of bid information to determine the values associated with the parameters specified. The processor 20 then displays the values associated with the input parameters in section 86. In other words, the first section 84 shows the input parameters that were selected in the configuration of the view to be used to aggregate the values shown in section 86.

A plurality of values can be determined and displayed in the section 82. Those values include: Freight, # Cntrs, Cntrs % of Row, Cntrs % of Bid, Freight/Cntr, Total FEU, FEU % of Row, FEU % of Bid, Freight/FEU, Total CUFT/CBM, CUFT % of Row, CUFT % of Bid, Freight/CUFT, Total LBS, LBS % of Row, LBS % of Bid, Freight/LBS, Total Cartons, Cartons % of Row, Cartons % of Bid, Freight/Carton, Quantity, Quantity % of Row, Quantity % of Bid, Freight/Piece, Avg Rate/FEU, Avg Rate/Cntr, Min Rate/FEU, Min Rate/Cntr, Max Rate/FEU, and Max Rate/Cntr. Each of these values is defined below.

Freight is defined as the cost.

# Cntrs is defined as Number of Containers

Cntrs % of Row is defined as the Number of Containers for the specific cell divided by the Number of Containers for the entire row*100. * indicates multiplication.

Cntrs % of Bid is defined as Number of Containers for the specific cell divided by the Number of Containers for the entire bid*100.

Freight/Cntr is defined as Cost per container

Total FEU is defined as Number of containers as expressed in forty foot equivalent units.

FEU % of Row is defined as FEU for the specific cell/FEU for the entire row*100

FEU % of Bid is defined as FEU for the specific cell/FEU for the entire bid*100.

Freight/FEU is defined as Cost per FEU.

Total CUFT/CBM is defined as Total Volume (CUFT=Cubic Feet when using Imperial system, CBM=Cubic Meters will be displayed if using Metric system).

CUFT % of Row is defined as Volume for the specific cell/Volume for the entire row*100.

CUFT % of Bid is defined as Volume for the specific cell/Volume for the entire bid.

Freight/CUFT is defined as Cost per Volume.

Total LBS is defined as Total Weight (LBS=Pounds when using Imperial system, KGS=kilograms when using Metric system).

LBS % of Row is defined as Weight for the specific cell/Weight for the entire row*100.

LBS % of Bid is defined as Weight for the specific cell/Weight for the entire bid*100.

Freight/LBS is defined as Cost per Weight.

Total Cartons is defined as Number of cartons.

Cartons % of Row is defined as Number of cartons for the specific cell/number of cartons for the entire row*100.

Cartons % of Bid is defined as Number of cartons for the specific cell/number of cartons for the entire bid*100.

Freight/Carton is defined as Cost per Carton.

Quantity is defined as Number of pieces being shipped.

Quantity % of Row is defined as Number of pieces being shipped for the specific cell/number of pieces being shipped for the entire row*100.

Quantity % of Bid is defined as Number of pieces being shipped for the specific cell/number of pieces being shipped for the entire bid*100.

Freight/Piece is defined as Cost per piece.

Avg Rate/FEU is defined as Average rate per FEU for all data represented by the specific cell.

Avg Rate/Cntr is defined as Average rate per Container for all data represented by the specific cell.

Min Rate/FEU is defined as Minimum rate per FEU for all data represented by the specific cell.

Min Rate/Cntr is defined as Minimum rate per Container for all data represented by the specific cell.

Max Rate/FEU is defined as Maximum rate per FEU for all data represented by the specific cell.

Max Rate/Cntr is defined as Maximum rate per Container for all data represented by the specific cell.

In accordance with an aspect of the invention, predefined views for display in the section 82 are provided. These predefined views are given a name and have predefined input parameters and predefined values that are calculated by referencing a database based on the input parameters.

In accordance with an aspect of the present invention, the predefined views, includes a Lane View, a Routing Overview View, a Rate Level View, a Region View, a Lane by Carrier View, a Projected Equipment Requirement by Carrier View, a City Level Lane/Carrier/Rates View, a Country Level Lane/Rate View, am Origin Carrier View, a Carrier/City Level Lane/Equipment View, a Carrier/Type-Size-Height/Math View, a Type-Size-Height/Math View, a Service View, and a Ranking View.

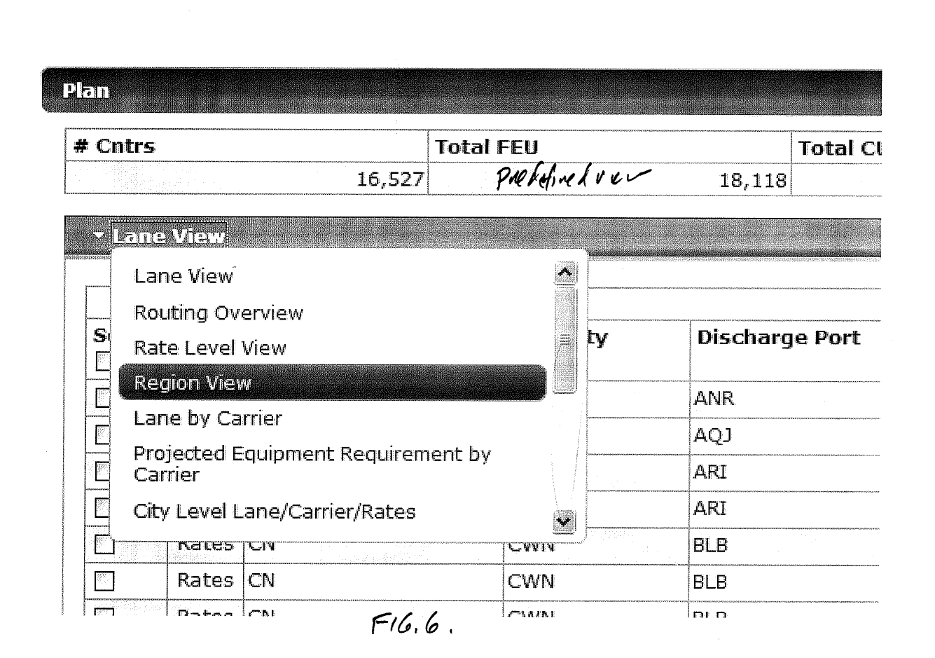

These predefined views can be accessed by selecting the Lane View link 88 in FIG. 5. This action causes the drop down list of FIG. 6 to be displayed. The drop down list of FIG. 6 includes a list of the predefined views. Selection of one of these views causes the predefined view to be displayed in section 82 of the bid comparison form of FIG. 5.

Each of these pre-defined views has input parameters that a processor 20 at the system administrator 14 uses to search a database to determine values associated with the predefined view. Each predefined view is described below, but other predefined views can be created.

The Lane View uses the following input parameters: Orig Country, Orig City, Discharge Port, Dest Country, Dest City, and Carrier. The output values displayed in the Lane View includes the total number of containers and the average rate/FEU. FEU stands for Forty foot Equivalent Unit as is well known in the art.

The Routing Overview View uses the following input parameters: Orig Region, Orig City, Dest Country, Dest City. The output values displayed in the Routing Overview View includes, by carrier, the Total FEU, Freight/FEU and the total Freight and Total FEU.

The Rate Level View uses the following input parameters: Carrier, Orig Country, Orig City, Load Port, Discharge Port, Dest Country, Dest City, Service Level, Equip Type, Equip Size, Equip Height. The output values displayed in the Rate Level View includes, Rate (Avg Rate/Cntr), Accessorial (Avg Rate/Cntr).

The Region View uses the following input parameters: Orig Region and Dest City. The output values displayed in the Region View includes, Equipment (# Cntrs, Cntrs % of Row), Carrier (# Cntrs).

The Lane by Carrier View uses the following input parameters: Orig Region, Orig City, Dest City. The output values displayed in the Lane by Carrier View includes Carrier (# Cntrs).

The Projected Equipment Requirement by CarrierView uses the following input parameters: Orig Region, Dest City. The output values displayed in the Projected Equipment Requirement by CarrierView includes Equipment (# Cntrs, Freight/Cntr, Freight/CUFT), Total (# Cntrs, Avg Rate/FEU).

The City Level Lane/Carrier/RatesView uses the following input parameters: Orig City, Orig Region, Dest Country, Dest City, Dest Site, Carrier. The output values displayed in the City Level Lane/Carrier/Rates View includes Total (# Cntrs, Cntrs % Bid), Rates (Freight).

The Country Level Lane/RateView uses the following input parameters: Orig Country, Dest Country. The output values displayed in the Country Level Lane/Rate View includes Total (# Cntrs, Cntrs % Bid), Rates (Freight).

The Origin Carrier View uses the following input parameters: Orig City. The output values displayed in the Origin Carrier View includes Carrier (Total FEU).

The Carrier/City Level Lane/Equipment View uses the following input parameters: Carrier, Orig City, Dest City. The output values displayed in the Carrier/City Level Lane/Equipment View includes Equipment (Freight, # Cntrs, Freight/Cntr).

The Carrier/Type-Size-Height/Math View uses the following input parameters: Carrier, Equip Type, Equip Size, Equip Height. The output values displayed in the Carrier/Type-Size-Height/Math View includes Total (Freight, # Cntrs, Freight/Cntr, Total FEU, Freight/FEU).

The Type-Size-Height/Math View uses the following input parameters: Equip Type, Equip Size, Equip Height. The output values displayed in the Type-Size-Height/Math View includes Total (Freight, # Cntrs, Freight/Cntr, Total FEU, Freight/FEU).

The Service View uses the following input parameters: Service Level. The output values displayed in the Service View includes Total (# Cntrs).

The Ranking View uses the following input parameters: Orig City, Orig Region, Equip Size, Carrier, Equip Type, Service Level, Dest Country. The output values displayed in the Ranking View includes Rates (Max Rate/Cntr), Accessorials (Freight), Total (Avg Rate/Cntr).

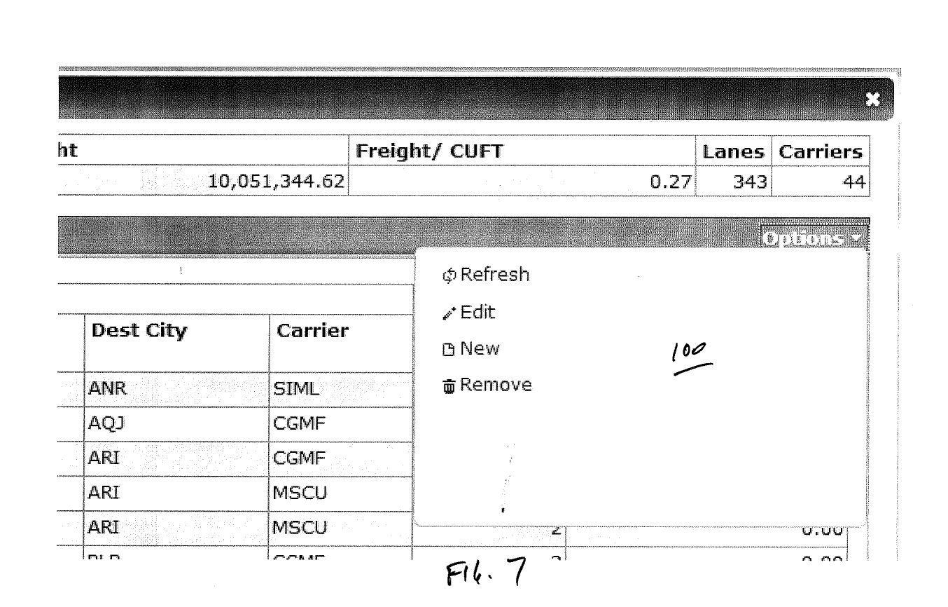

When the options link 90 in FIG. 5 is selected, the drop down menu 100 in FIG. 7 is shown on a display. The menu allows the bid comparison form of FIG. 5 to be refreshed. It can also be edited, so that new input parameters and/or values are displayed. A new view (from the predefined views) can be selected. The present view can also be removed.

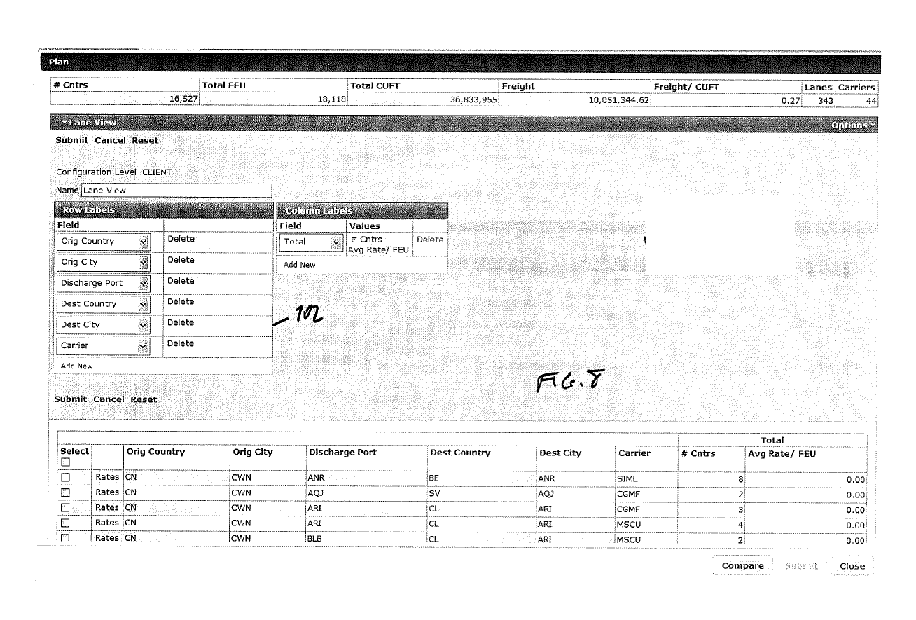

FIG. 8 illustrates the editing feature. When edit is selected, the row labels can be selected in area 102. When Add New is selected, new input parameters can be selected. Alternatively, by selecting delete, input parameters can be deleted.

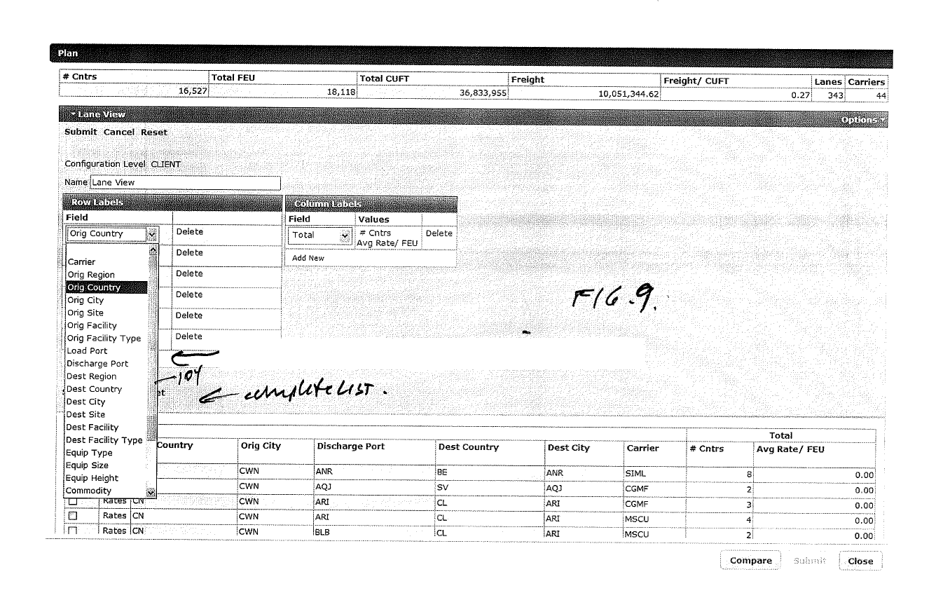

FIG. 9 illustrates the selection of the row variables that are displayed in section 84 of FIG. 5 and that are used to determine the values. When new is selected in FIG. 7 or when Add New is selected in FIG. 8, the entire list of input parameters is displayed in a drop down list box under the word Field at 104. These items can be selected to populate the list of input parameters (such as shown in FIG. 8).

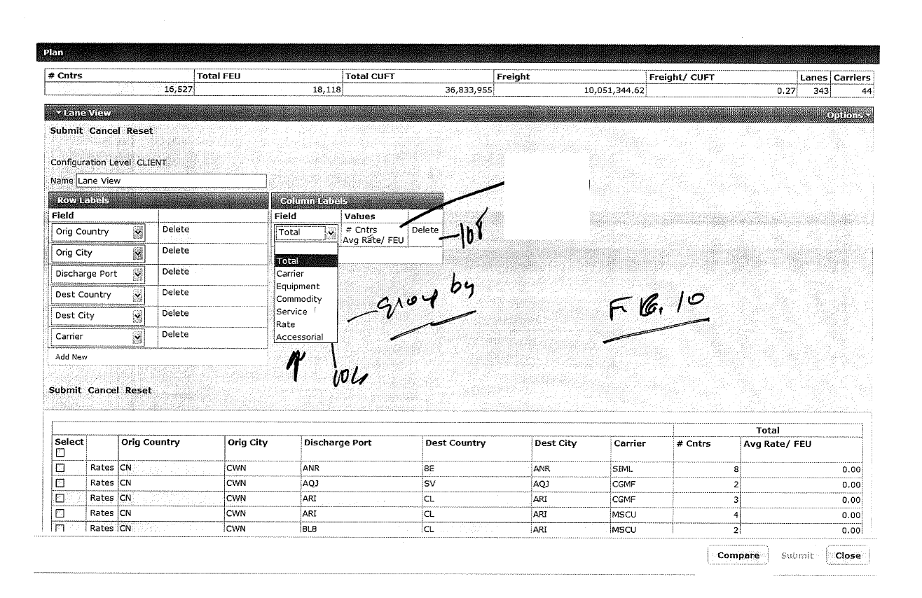

The outputs shown in section 86 of FIG. 5 can be selectively grouped. In FIG. 5, the values are grouped by totals. The values can be grouped by carrier, equipment, by commodity, by service, by rate or by accessorial. The carrier is the company that is filling ut the bid and perhaps transporting the goods. The equipment is the type of box that the goods will be transported in. For example, it may be a 20 foot long, 86 inch high dry container or a 40 foot long, 96 inch high refrigerated container. Service refers to the method of transportation that will be used. For example, it could be water, train or truck. The rate is the base rate charge for transportation. Accessorial refers to additional charges that may apply. The grouping is selected in drop down list box 106 shown in FIG. 10.

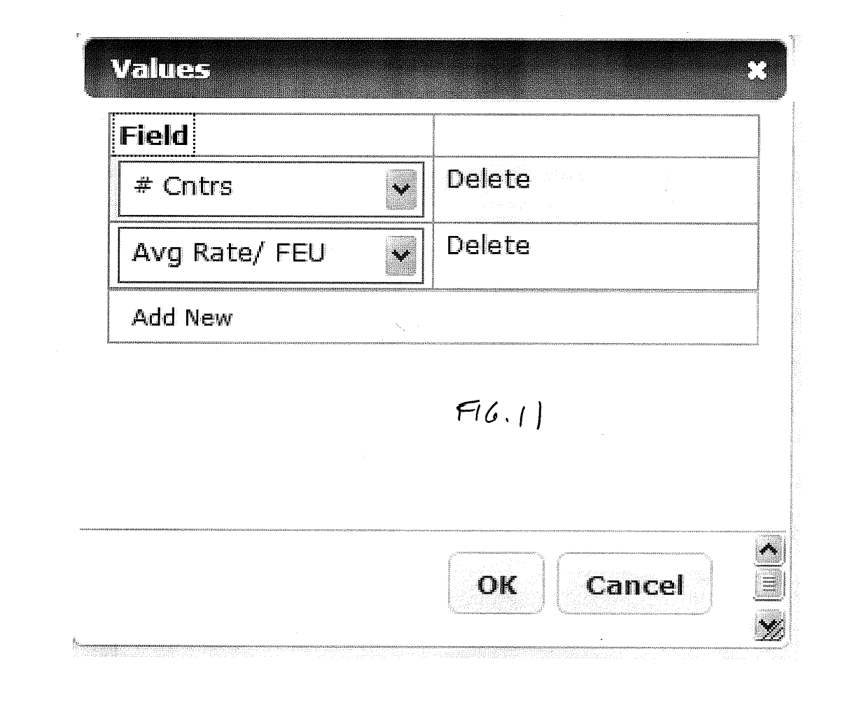

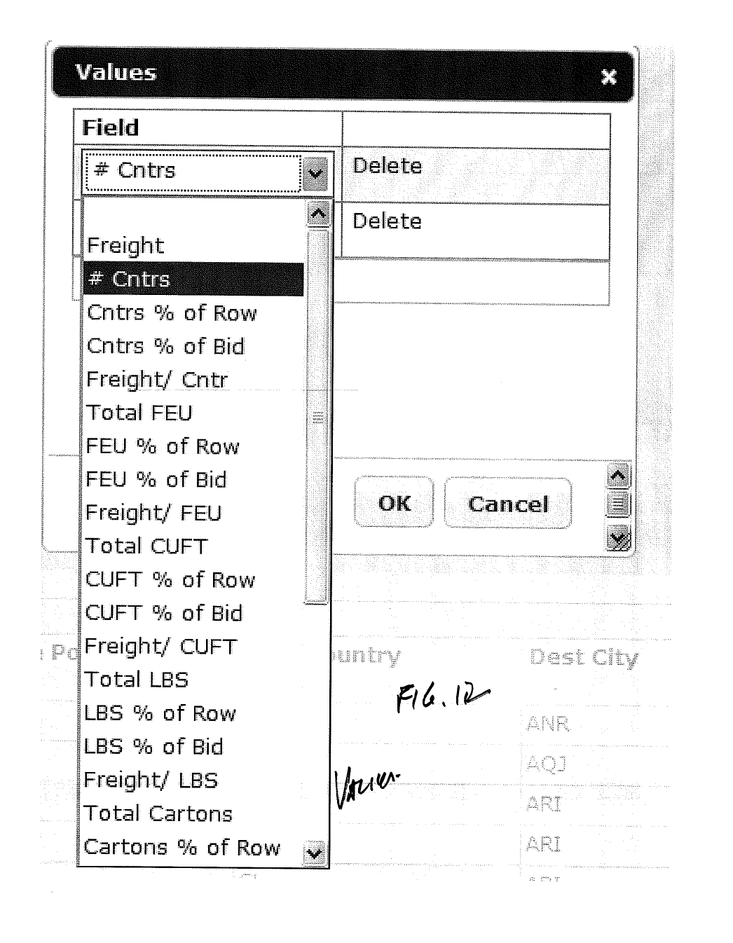

The values in section 86 are also selectable. When the link 108 in FIG. 10 is selected, then a list of the values is displayed. Those values, described before, can be selected as shown in FIGS. 11 and 12. For example, the list in FIG. 12, using the scroll function, can show all of the values that can be selected. The link 108 in FIG. 10 is updated to reflect the values selected.

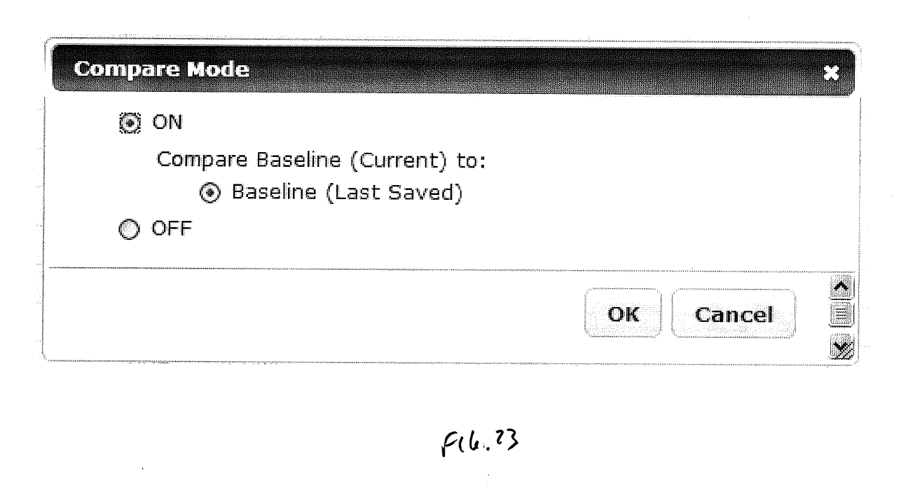

The comparison section 80 in FIG. 5 can be disabled. Referring to FIG. 13, a COMPARE button is provided. The same button, although not shown, is provided in FIG. 5. When that button is selected, FIG. 13 is displayed. FIG. 13 allows the comparison section 80 to be selectively enabled or disabled.

In some applications, the company 12 can serve as the system administrator 14 as well. Thus, the system administrator 14 functions can be located at the company's servers. Alternatively, the company 12 can maintain additional servers at another location on the network 10 to implement the functions of the system administrator 14. In this embodiment of the present invention, all of the functions that are described as being performed by a system administrator 14 are still performed by a system administrator, but the system administrator is located at the company's 12 server or servers.

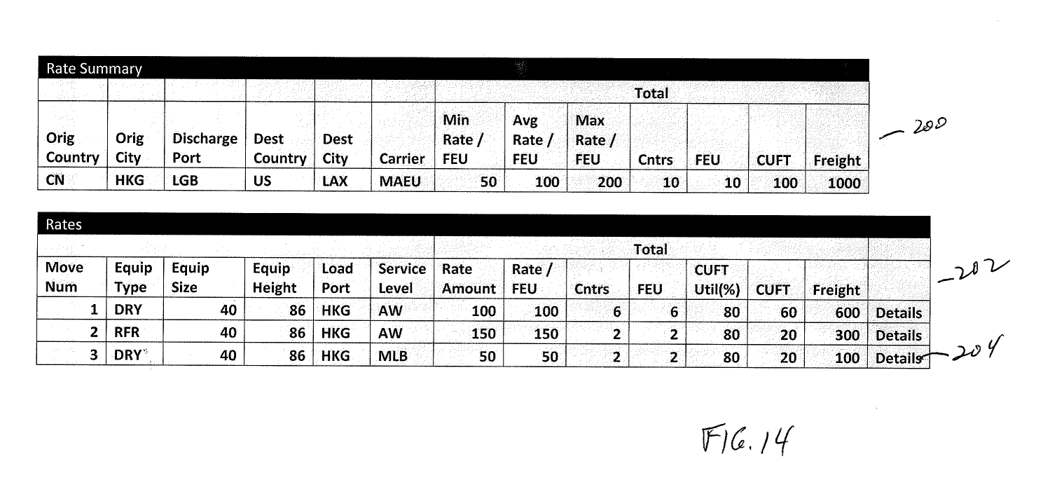

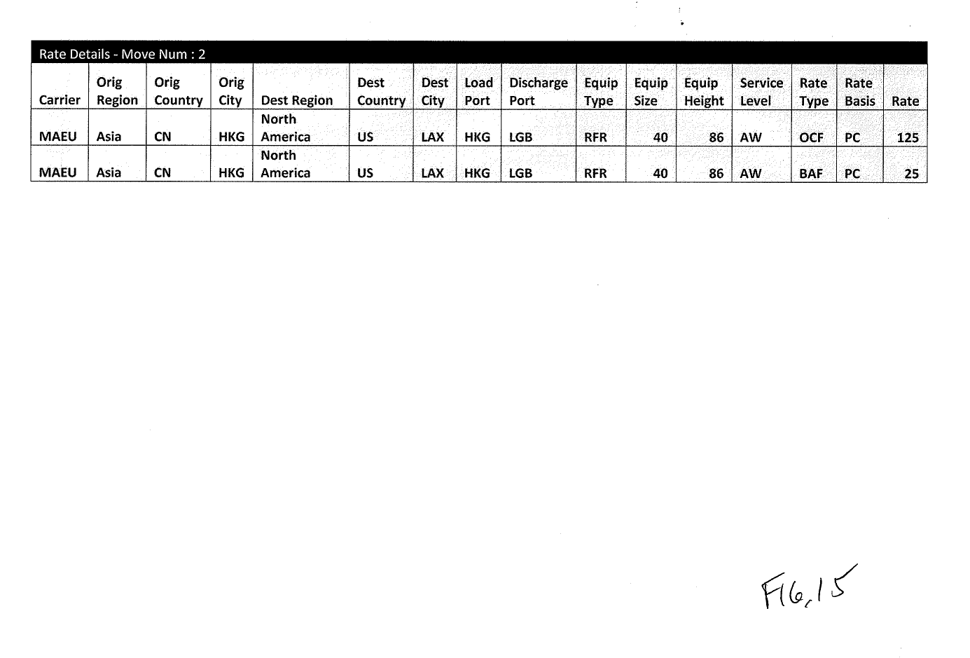

In accordance with another aspect of the present invention, it is possible to drill down to investigate rates. This process is illustrated in FIGS. 14 and 15. To start drilling down into the information provided, one clicks on the Rates link 92 in FIG. 5. Clicking the Rates link 92 allows the user to drill down into the aggregated data that is represented by the row containing the Rates link. Thus, all of the information that was accessed to generate the summary of the row in FIG. 5 is illustrated in a plurality of rows in FIG. 14.

FIG. 14 illustrates the window that opens when the Rates link 92 in the third row of FIG. 5 is clicked. The third row in FIG. 5 has accumulated data relating to the situation where the origin country is China, the Origin City is Hong Kong, the Discharge Port is LGB, the Destination Country is the US, the Destination City is Los Angeles (LAX) and the carrier is MAEU, as determined from Section 84 of FIG. 5. A summary of the information relating to the specified input parameters is provided in section 200 of FIG. 14. A listing of all of the moves that generated the value information is displayed in section 202. Thus, it can be seen that there were three moves that were related to the input parameters specified and that those three moves includes a total of 10 containers and that the average rate per FEC was 100. This information is therefore displayed in FIG. 5 and in section 200 of FIG. 14.

Thus, FIG. 14 allows a user to view a summary of the rate information for a specified row in FIG. 5 as well as a breakdown of the rates that contribute to the summary which is represented as a list of moves. A move is defined as the unique combination of primary attributes that a carrier has provided a rate for the transportation of goods.

If the user desires further information, the user can click on the Details link 204 in the Rate Summary window of FIG. 14. This action will open the Rate Details window, shown in FIG. 15, which displays the specific charges entered by the carrier that apply to a move.

FIG. 15 shows the information related to move number 2 in the listing in section 202 of FIG. 14. The first row of information in FIG. 15 illustrates that of the 150 rate amount, 125 of it was allocated to a first purpose and 25 was allocated for extra charges, for example, an extra fuel charge.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method of providing a freight bid to a party over a network, comprising a processor:
receiving by the processor a completed bid request form from the party over the network, a completed bidding interface specifying a lane, one or more carriers and a plurality of parameters to specify a bid;
accessing a database of historical bidding information including historical rate information by the processor using the lane and at least one of the plurality of parameters to determine a preliminary baseline of information based on the historical rate information related to the bid;
transmitting by the processor of a bid form to the one or more carriers over the network, the bid form including the lane and the plurality of parameters to be completed;
receiving a completed bid form by the processor from the one or more carriers over the network, the completed bid form specifying the lane and information relating to the plurality of parameters;
accessing the database by the processor using the lane and the set of information related to the plurality of parameters to determine a second baseline related to the bid, the second baseline including rate information provided by a first carrier in a first and second round of bidding; and
transmitting a bid comparison form by the processor to the party over the network, the bid comparison form including the preliminary baseline next to the second baseline and a freight rate based on an aggregation of values of at least one of the plurality of parameters including viewable rates of a plurality of moves of freight over the lane.

2. The method of claim 1, further comprising:
the processor calculating one or more differences between the second baseline and the preliminary baseline and showing the difference on the bid comparison form, wherein a combination of two or more of the plurality of parameters defines a view of the bid comparison form, and
the processor applying the view to compare the bid comparison form with a modified bid comparison form.

3. The method of claim 1, further comprising the processor, in a first step, transmitting an uncompleted bid request form over the network to the party, the uncompleted bid form including entry fields for the party to specify the lane and the plurality of parameters related to the bid.

4. The method of claim 1, wherein the completed bidding interface specifies the bidder, the processor uses the bidder to access the database to determine the preliminary baseline, and the processor uses the bidder to access the database to determine the second baseline.

5. The method of claim 1, wherein the plurality of parameters is selected from the group consisting of ORIGIN REGION, ORIGIN CITY, ORIGIN CITY NAME, ORIGIN SITE, ORIGIN FACILITY, ORIGIN FACILITY TYPE, ORIGIN COUNTRY, DESTINATION REGION, DESTINATION CITY, DESTINATION CITY NAME, DESTINATION SITE, DESTINATION FACILITY, DESTINATION FACILITY TYPE, DESTINATION COUNTRY, LOAD PORT, DISCHARGE PORT, TYPE OF CONTAINER, SIZE OF CONTAINER, HEIGHT OF CONTAINER, COMMODITY CODE, SERVICE LEVEL, RATES, ORIG DATE, DEST DATE, EFFECTIVE DATE, EXPIRATION DATE, and combinations thereof.

6. A system of providing a freight bid to a party over a network, comprising:
a server being able to communicate over the network;
the server including a memory to store data and a set of operating instructions and a processor in communication with the memory, the processor operable in accordance with the set of operating instructions to:
receive a completed bid request form from the party over the network, the completed bidding interface specifying a lane, one or more carriers and a plurality of parameters to specify a bid;
access the memory to retrieve historical bidding information including a historical freight rate using the lane and at least one of the plurality of parameters to determine a preliminary baseline of information based on the historical rate information related to the bid;
transmit a bid form to the one or more carriers over the network, the bid form including the lane and the plurality of parameters to be completed;
receive a completed bid form from the one or more carriers over the network, the completed bid form specifying the lane and information relating to the plurality of parameters;
access the memory using the lane and the set of information related to the plurality of parameters to determine a second baseline related to the bid including rate information provided by a first carrier in a first and second round of bidding; and
transmit a bid comparison form to the party over the network, the bid comparison form including the preliminary baseline next to the second baseline and a freight rate based on an aggregation of values of at least one of the plurality of parameters including viewable rates of a plurality of moves of freight over the lane.

7. The system of claim 6, further comprising the processor calculating one or more differences between the second baseline and the preliminary baseline and showing the difference on the bid comparison form.

8. The system of claim 6, further comprising the processor, in a first step, transmitting an uncompleted bid request form over the network to the party, the uncompleted bid form including entry fields for the party to specify the lane and the plurality of parameters related to the bid.

9. The system of claim 6, wherein the completed bidding interface specifies the bidder, the processor uses the bidder to access the memory to determine the preliminary baseline, and the processor uses the bidder to access the memory to determine the second baseline.

10. The system of claim 6, wherein the plurality of parameters is selected from the group consisting of ORIGIN REGION, ORIGIN CITY, ORIGIN CITY NAME, ORIGIN SITE, ORIGIN FACILITY, ORIGIN FACILITY TYPE, ORIGIN COUNTRY, DESTINATION REGION, DESTINATION CITY, DESTINATION CITY NAME, DESTINATION SITE, DESTINATION FACILITY, DESTINATION FACILITY TYPE, DESTINATION COUNTRY, LOAD PORT, DISCHARGE PORT, TYPE OF CONTAINER, SIZE OF CONTAINER, HEIGHT OF CONTAINER, COMMODITY CODE, SERVICE LEVEL, RATES, ORIG DATE, DEST DATE, EFFECTIVE DATE, EXPIRATION DATE, and combinations thereof.
